(19) United States
(12) Patent Application Publication
(10) Pub. No.: US 2025/0237842 A1
(43) Pub. Date: Jul. 24, 2025

(54) OPTICAL UNIT

(71) Applicant: NIDEC INSTRUMENTS CORPORATION, Nagano (JP)

(72) Inventor: YUKI KONDO, Nagano (JP)

(73) Assignee: NIDEC INSTRUMENTS CORPORATION, Nagano (JP)

(21) Appl. No.: 19/015,503

(22) Filed: Jan. 9, 2025

(30) Foreign Application Priority Data
Jan. 19, 2024 (JP) 2024-006583

(51) Int. Cl. G02B 7/02

(52) U.S. Cl. CPC G02B 7/02

(57) ABSTRACT

An optical unit comprising: a fixed body; a movable body provided with a lens unit; and a gimbal mechanism which supports the movable body relative to the fixed body such that the movable body is rotatable about a direction intersecting an optical axis direction as an axis of rotation, in which: the gimbal mechanism includes a fixed-body-side leg portion connected to the fixed body, and a movable-body-side leg portion connected to the movable body; and in at least one of the fixed body and the fixed-body-side leg portion as a pair and the movable body and the movable-body-side leg portion as a pair, corresponding members of the pair are directly connected to each other without any other member interposed therebetween.

### CROSS-REFERENCE TO RELATED APPLICATION

This application claims the priority benefit of Japan application serial no. 2024-006583, filed on Jan. 19, 2024. The entirety of the above-mentioned patent application is hereby incorporated by reference herein and made a part of this specification.

### BACKGROUND

### Field of the Invention

At least an embodiment of the present invention relates to an optical unit.

### Description of the Related Documents

Conventionally, various optical units have been used. Among the conventional optical units, there are known various optical units including a fixed body, a movable body provided with a lens unit, and a gimbal mechanism which supports the movable body such that the movable body is rotatable relative to the fixed body about a direction intersecting an optical axis direction as an axis of rotation. For example, Japanese Unexamined Patent Application Publication No. 2023-67974 discloses an optical unit including a fixed body, a movable body provided with an optical module, and a gimbal mechanism which supports the movable body such that the movable body is rotatable relative to the fixed body about a first direction and a second direction, which intersect an optical axis direction, as an axis of rotation. Further, Japanese Unexamined Patent Application Publication No. 2023-97490 discloses an optical unit including a fixed body, a movable body provided with a camera module, and an intermediate member which supports the movable body such that the movable body is rotatable relative to the fixed body about a first intersecting direction and a second intersecting direction, which intersect an optical axis direction, as an axis of rotation.

In a conventional optical unit including a fixed body, a movable body provided with a lens unit, and a gimbal mechanism which supports the movable body such that the movable body is rotatable relative to the fixed body about a direction intersecting an optical axis direction as an axis of rotation, as in the optical units of Japanese Unexamined Patent Application Publication No. 2023-67974 and Japanese Unexamined Patent Application Publication No. 2023-97490, the fixed body and the movable body are connected to the gimbal mechanism via another member. For example, in the optical unit of Japanese Unexamined Patent Application Publication No. 2023-67974, the fixed body and the movable body are connected to the gimbal mechanism via a thrust receiving member. Further, in the optical unit of Japanese Unexamined Patent Application Publication No. 2023-97490, the movable body and the gimbal mechanism are connected to each other via a first supporting member, and the fixed body and the gimbal mechanism are connected to each other via a second supporting member.

However, in a configuration in which the fixed body and the movable body are connected to the gimbal mechanism via another member as in the optical units of Japanese Unexamined Patent Application Publication No. 2023-67974 and Japanese Unexamined Patent Application Publication No. 2023-97490, not only is the size of the other member added to the optical unit, but there also arises the need for providing an area for bonding or welding the other member to the fixed body and the movable body. For this reason, a connection portion of the fixed body and the movable body to the gimbal mechanism tends to increase in size, and a problem to be addressed is that the optical unit is increased in size.

### SUMMARY

Hence, an optical unit of at least an embodiment of the present invention includes: a fixed body; a movable body provided with a lens unit; and a gimbal mechanism which supports the movable body such that the movable body is rotatable relative to the fixed body about a direction intersecting an optical axis direction as an axis of rotation, in which: the gimbal mechanism includes a fixed-body-side leg portion connected to the fixed body, and a movable-body-side leg portion connected to the movable body; and in at least one of the fixed body and the fixed-body-side leg portion as a pair and the movable body and the movable-body-side leg portion as a pair, corresponding members of the pair are directly connected to each other without any other member interposed therebetween.

The optical unit of at least an embodiment of the present invention can be reduced in size.

### BRIEF DESCRIPTION OF THE DRAWINGS

Embodiments will now be described, by way of example only, with reference to the accompanying drawings which are meant to be exemplary, not limiting, and wherein like elements are numbered alike in several figures, in which:

FIG. 1 is a perspective view of an optical unit according to one embodiment of the present invention as seen from a subject side;

FIG. 2 is a perspective view of the optical unit of FIG. 1 as seen from a side opposite the subject side;

FIG. 3 is an exploded perspective view of the optical unit of FIG. 1;

FIG. 4 is an exploded perspective view of the optical unit of FIG. 1 as seen from an angle different from that of FIG. 3;

FIG. 5 is a perspective view of a part at the periphery of a connection portion between a fixed body and a gimbal mechanism of the optical unit of FIG. 1;

FIG. 6 is a perspective view of a part at the periphery of a connection portion between a movable body and a gimbal mechanism of the optical unit of FIG. 1;

FIG. 7 is a cross-sectional view of a part at the periphery of a connection portion between a movable body and a gimbal mechanism of the optical unit of FIG. 1 as viewed from a V-V direction in FIG. 6;

FIG. 8 is a view of a part at the periphery of a connection portion between a movable body and a gimbal mechanism of the optical unit of FIG. 1, and shows a movable-body-side leg portion of the gimbal mechanism in cross section; and

FIG. 9 is a planar cross-sectional view of a part at the periphery of a connection portion between a movable body and a gimbal mechanism of the optical unit of FIG. 1 as viewed from a W-W direction in FIG. 8.

### DETAILED DESCRIPTION

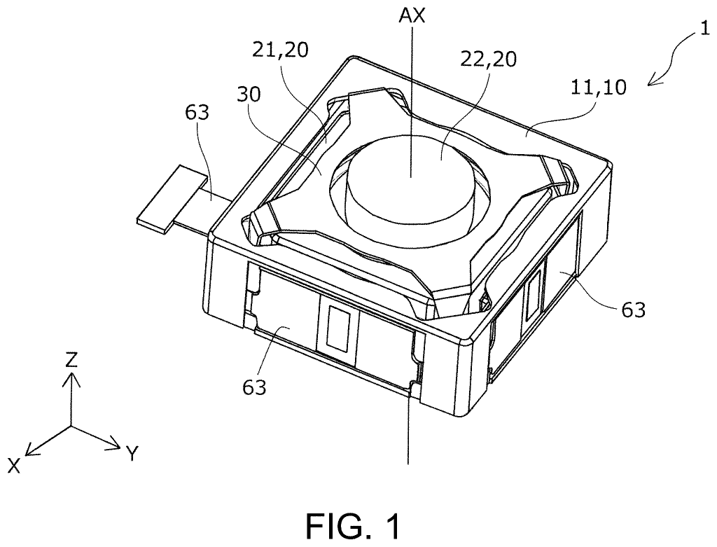

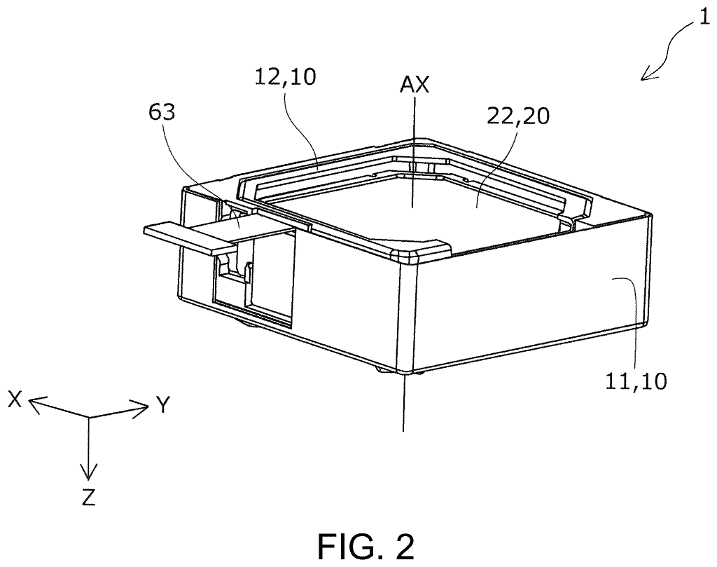

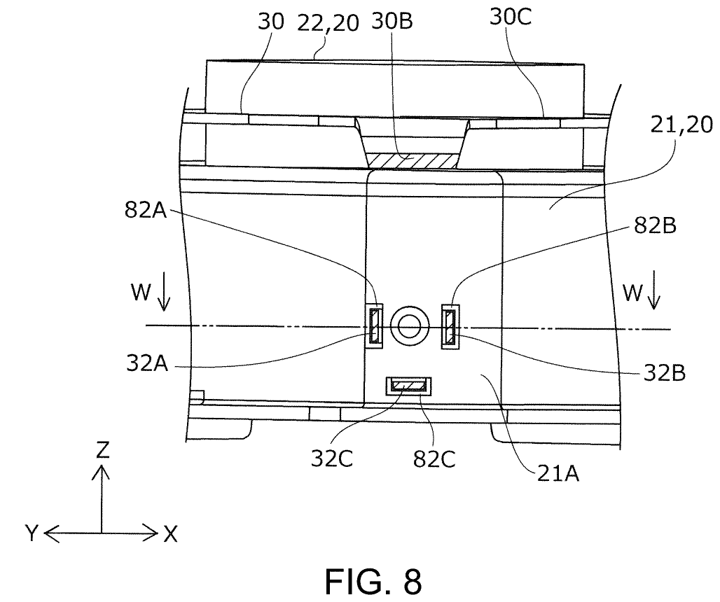

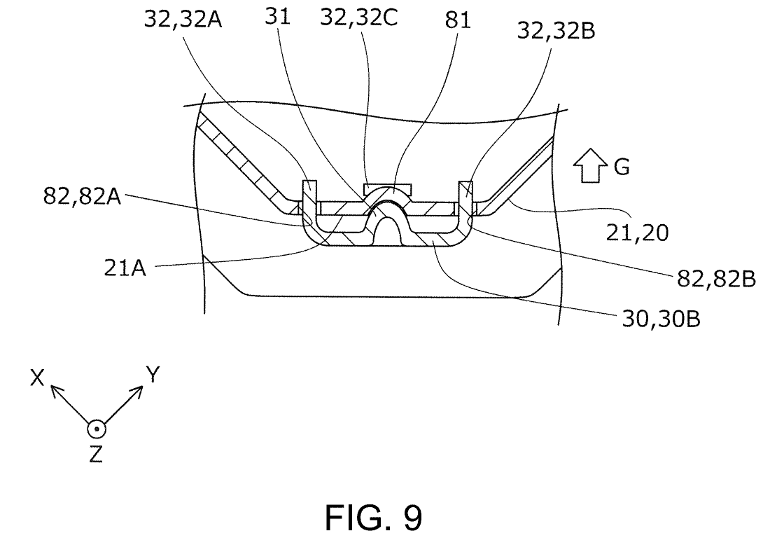

An optical unit 1 according to an embodiment of the present invention will be described below with reference to FIGS. 1 to 9. In the drawings, a Z-axis direction corresponds to an optical axis direction, an X-axis direction corresponds to a direction intersecting an optical axis AX, in other words, a yaw axis direction, and a Y-axis direction corresponds to a direction intersecting the optical axis AX, in other words, a pitch axis direction. Further, in the Z-axis direction, +Z direction, which is the direction in which an arrow is directed, is the direction on a subject side, and −Z direction, which is the direction opposite the direction in which the arrow is directed, is the direction on a counter-subject side opposite the subject side. Furthermore, in the present specification, a direction intersecting the Z-axis direction is referred to as a width direction, and both the X-axis direction and the Y-axis direction correspond to one direction of the width direction.

The optical unit 1 of the present embodiment is provided with a movable body 20 including a lens unit 22 and a fixed body 10 surrounding the movable body 20 in a circumferential direction intersecting the optical axis direction (the Z-axis direction) of the lens unit 22. Further, the optical unit 1 of the present embodiment is provided with a gimbal mechanism 30 which supports the movable body 20 such that the movable body is rotatable relative to the fixed body 10 about a direction intersecting the optical axis direction (i.e., the X-axis direction and the Y-axis direction) as an axis of rotation. Furthermore, the optical unit 1 of the present embodiment is provided with a drive portion 60 including a coil 61 that is disposed on the fixed body 10, and a magnet 62 (magnets 62A and 62B) disposed at a position of the movable body 20 that is opposed to the coil 61 (coils 61A and 61B). Note that the coils 61 are provided on the inner side of a flexible printed circuit board 63 attached to the fixed body 10 as seen from the optical axis direction.

### Overall Configuration of Optical Unit

First, an overall configuration of the optical unit 1 of the present embodiment will be described. The optical unit 1 of the present embodiment can be preferably used for a camera, a smartphone, or the like. This is because the optical unit 1 of the present embodiment can be configured to be compact, and a camera or a smartphone can be made to have a compact configuration. However, the use of the optical unit 1 of the present embodiment is not limited to a camera or a smartphone, and the optical unit 1 of the present embodiment can be used in various devices without any particular limitation on the use.

The optical unit 1 of the present embodiment is provided with the movable body 20 including the lens unit 22 in which a lens, for example, is provided. The movable body includes the lens unit 22 and a holder 21 which surrounds the movable body 20 in the circumferential direction intersecting the optical axis direction (the Z-axis direction) of the lens unit 22. In addition, the optical unit 1 of the present embodiment is provided with the fixed body 10 which covers the lens unit 22 from the +Z direction in a state in which a part of the lens unit 22 is exposed. The fixed body 10 includes a housing portion 11, a metal case 12 which is accommodated in the housing portion 11 and surrounds the movable body 20 in the circumferential direction, and a resin case 13 which is attached to the outer side of the metal case 12. Also, the optical unit 1 of the present embodiment is provided with the gimbal mechanism 30 between the movable body 20 and the fixed body 10, in which the gimbal mechanism 30 includes: a fixed-body-side leg portion 30A connected to the fixed body 10; a movable-body-side leg portion 30B connected to the movable body 20; and a flat plate portion 30C provided with the fixed-body-side leg portion 30A and the movable-body-side leg portion 30B. The gimbal mechanism 30 has springiness, and supports the movable body 20 relative to the fixed body 10 rotatably about the X-axis direction and the Y-axis direction as the axis of rotation.

### Movable Body

The movable body 20 has a substantially cuboid shape. The lens unit 22 is held inside the holder 21 as seen from the optical axis direction, and is disposed such that a portion where the lens is formed protrudes from a surface of the holder 21 in the +Z direction. Further, on a side surface of the holder 21 in the +X direction, the magnet 62A as the magnet 62, which constitutes the drive portion 60 that moves the movable body 20 relative to the fixed body 10, is provided. Furthermore, on a side surface of the holder 21 in the +Y direction, the magnet 62B as the magnet 62 which constitutes the drive portion 60 is provided. Here, the magnets 62A and 62B both have the same configuration. It can be considered that the magnet 62A and the magnet 62B also form a part of the movable body 20.

### Fixed Body

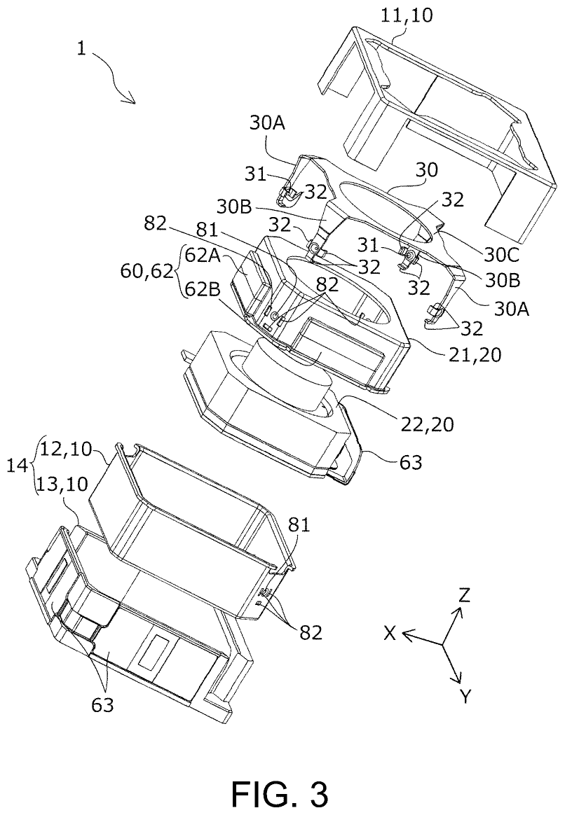

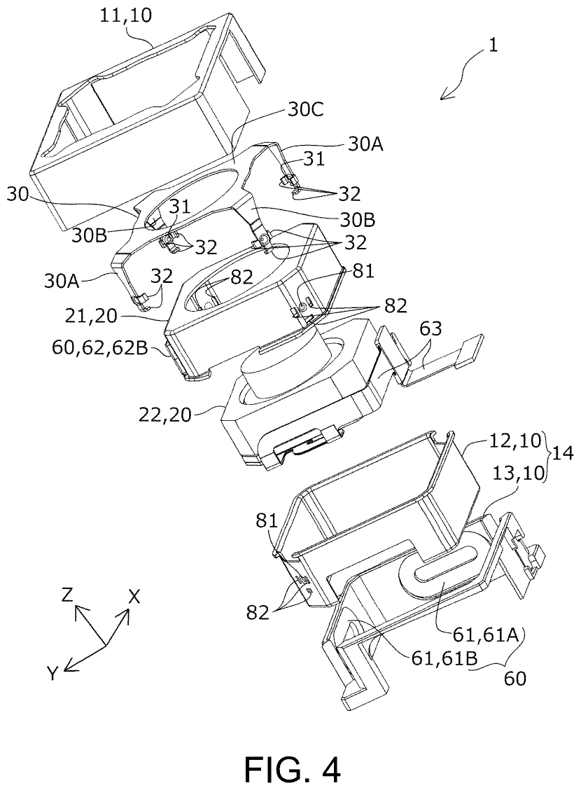

The fixed body 10 has a substantially cuboid shape. In the fixed body 10, the metal case 12 to which the resin case 13 is attached is disposed inside the housing portion 11. Further, the movable body 20 is disposed on the inner side of the metal case 12 as seen from the optical axis direction. Here, as illustrated in FIGS. 3 and 4, the metal case 12 and the resin case 13 constitute a case portion 14. Further, the coils 61 constituting the drive portion 60 are respectively provided on a side surface of the resin case 13 on the +X direction side and a side surface of the same on the +Y direction side. These coils 61 are disposed at positions opposed to the magnets 62A and 62B. Here, the coil 61A of the coils 61, which is at a position opposed to the magnet 62A, and the coil 61B of the coils 61, which is at a position opposed to the magnet 62B, have the same configuration.

### Gimbal Mechanism

The gimbal mechanism 30 includes the flat plate portion 30C which has a circular hole part through which the portion where the lens is formed of the lens unit 22 passes and the outer shape of which is rectangular, and the fixed-body-side leg portion 30A and the movable-body-side leg portion 30B, which are connection portions between the fixed body 10 and the movable body 20. The fixed-body-side leg portion 30A and the movable-body-side leg portion 30B are formed on the four corners of the rectangular flat plate portion 30C. The fixed-body-side leg portions 30A, which are two connection portions on a diagonal line among the leg portions, are rotatably connected to the fixed body 10, and the movable-body-side leg portions 30B, which are two connection portions on another diagonal line, are rotatably connected to the movable body 20. The connection portion between the fixed body 10 and the fixed-body-side leg portion 30A and the connection portion between the movable body 20 and the movable-body-side leg portion 30B will be described later in detail.

The optical unit 1 of the present embodiment is configured such that the gimbal mechanism 30 allows the movable body 20 to be rotatable relative to the fixed body 10 in the yaw axis direction and the pitch axis direction. However, a mechanism different from the gimbal mechanism 30 may further be provided, for example, to allow the movable body 20 to be rotatable relative to the fixed body 10 in a rolling direction.

### Drive Portion

Next, the drive portion 60 will be described. As described above, the magnet 62A and the magnet 62B have the same configuration and the two coils 61A and 61B respectively disposed at positions opposed to the magnet 62A and the magnet 62B have the same configuration. The optical unit 1 of the present embodiment includes, as the drive portion 60, a pitch axis rotation mechanism configured from the magnet 62A and the coil 61A, and a yaw axis rotation mechanism configured from the magnet 62B and the coil 61B. However, the optical unit 1 of the present embodiment is not limited to such a configuration, and may have a configuration including only one of the pitch axis rotation mechanism and the yaw axis rotation mechanism. Further, the optical unit 1 of the present embodiment may be provided with a roll axis rotation mechanism which allows the movable body 20 to be rotatable relative to the fixed body 10 in the rolling direction.

Connection Portion of Fixed Body and Movable Body to Gimbal Mechanism Next, the connection portion between the fixed body 10 and the fixed-body-side leg portion 30A and the connection portion between the movable body 20 and the movable-body-side leg portion 30B will be described. There are two connection portions between the fixed body 10 and the fixed-body-side leg portion 30A, and there are also two connection portions between the movable body 20 and the movable-body-side leg portion 30B. These connection portions all have the same configuration. Therefore, in the following description of the connection portion of the fixed body 10 and the movable body 20 to the gimbal mechanism 30, the fixed body 10 can be read as the movable body 20, and the fixed-body-side leg portion 30A can be read as the movable-body-side leg portion 30B. Conversely, the movable body 20 can be read as the fixed body 10, and the movable-body-side leg portion 30B can be read as the fixed-body-side leg portion 30A.

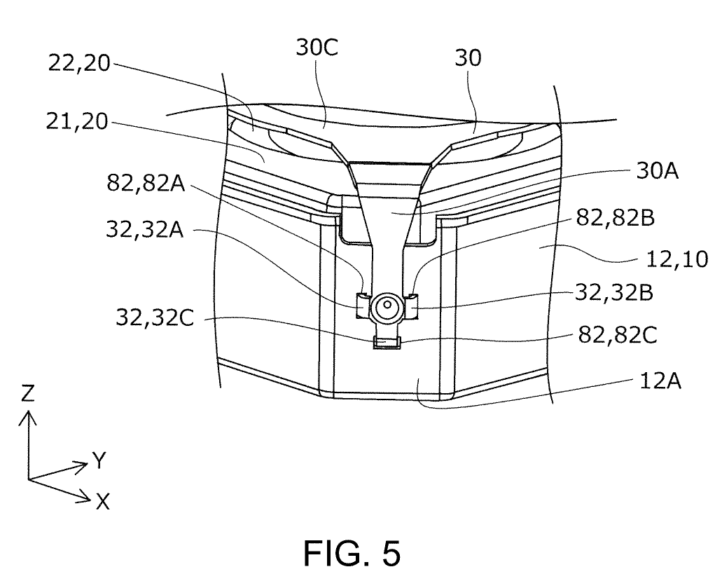

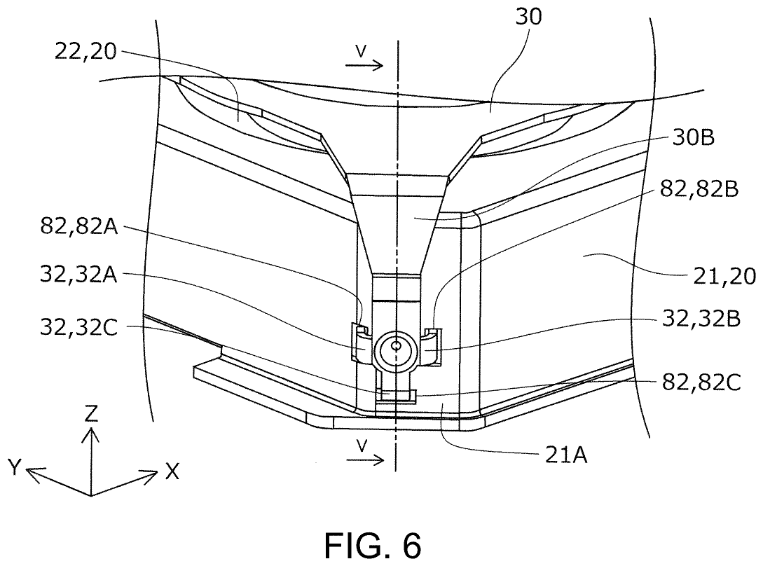

As illustrated in FIGS. 3 and 4, a convex portion 31 protruding toward the inner side is provided on the fixed-body-side leg portion 30A of the gimbal mechanism 30. In addition, a concave portion 81 being recessed toward the inner side is provided at a position of a connection surface 12A (refer to FIG. 5) of the fixed body 10 where the convex portion 31 is to be disposed when the gimbal mechanism 30 is connected to the fixed body 10. Similarly, the convex portion 31 protruding toward the inner side is provided on the movable-body-side leg portion 30B of the gimbal mechanism 30. In addition, the concave portion 81 being recessed toward the inner side is provided at a position of a connection surface 21A (refer to FIGS. 6 to 8) of the movable body 20 where the convex portion 31 is to be disposed when the gimbal mechanism 30 is connected to the movable body 20.

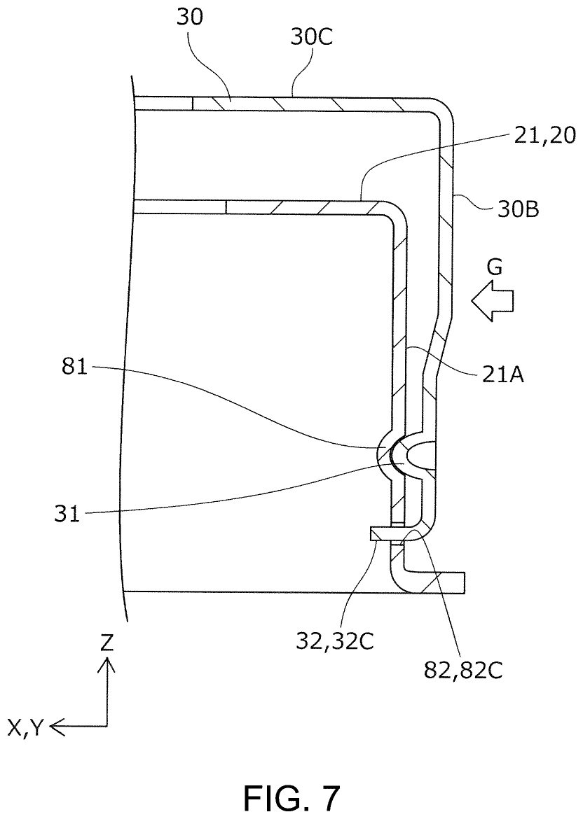

Since the fixed body 10, the movable body 20, and the gimbal mechanism 30 have such a configuration, as illustrated in FIG. 7, for example, the convex portion 31 is engaged with the concave portion 81 at each of the corresponding convex portion 31 and concave portion 81. As illustrated in FIG. 7, when the gimbal mechanism 30 is connected to the movable body 20, the movable-body-side leg portion 30B is fitted to the connection surface 21A of the movable body 20 from the outside. In doing so, a pressure G is applied by the springiness of the movable-body-side leg portion 30B. Similarly, although not illustrated, when the gimbal mechanism 30 is connected to the fixed body 10, the fixed-body-side leg portion 30A is fitted to the connection surface 12A of the fixed body 10 from the outside. In doing so, the pressure G is applied by the springiness of the fixed-body-side leg portion 30A. Owing to such a configuration, the fixed body 10 and the fixed-body-side leg portion 30A are directly connected to each other without any other member interposed therebetween, and also the movable body 20 and the movable-body-side leg portion 30B are directly connected to each other without any other member interposed therebetween.

For now, to give a summary of the above, the optical unit 1 of the present embodiment is provided with: the fixed body 10; the movable body 20 provided with the lens unit 22; and the gimbal mechanism 30 which supports the movable body 20 such that the movable body 20 is rotatable relative to the fixed body 10 about the X-axis direction and the Y-axis direction, which intersect the optical axis direction, as the axis of rotation. Here, the gimbal mechanism 30 includes the fixed-body-side leg portion 30A that is connected to the fixed body 10, and the movable-body-side leg portion 30B that is connected to the movable body 20.

Further, the fixed body 10 and the fixed-body-side leg portion 30A, and the movable body 20 and the movable-body-side leg portion 30B are directly connected to each other without any other member such as a thrust receiving member interposed therebetween. Expressed differently, the optical unit 1 of the present embodiment has such a configuration that the gimbal mechanism 30 is able to support the fixed body 10 rotatably about a direction intersecting the optical axis direction as the axis of rotation without using another member, and that the gimbal mechanism 30 is able to support the movable body 20 rotatably about a direction intersecting the optical axis direction as the axis of rotation without using another member. That is, the phrase “directly connected to each other without any other member interposed therebetween” can be read as “connected without using any other member”.

As can be seen in the optical unit 1 of the present embodiment, in at least one of the fixed body 10 and the fixed-body-side leg portion 30A as a pair and the movable body and the movable-body-side leg portion 30B as a pair, corresponding members of the pair are directly connected to each other without any other member interposed therebetween. Consequently, at the connection portion of the fixed body 10 and the movable body 20 to the gimbal mechanism 30, it is possible to eliminate the need for separately preparing a connecting member (for example, a thrust receiving member) for connecting the fixed body 10 and the movable body 20 to the gimbal mechanism 30.

For example, by eliminating the need for separately preparing a connecting member such as a thrust receiving member, the number of members can be reduced, and a connection process for connecting the connecting member can also be eliminated. Further, as the size of the connection portion can be reduced, the size of the optical unit 1 can be reduced.

Further, when a configuration in which a connecting member is separately prepared is adopted, for example, there may be a case where the connecting member needs to be bonded or welded to the connection surface 12A or the connection surface 21A. However, by employing a configuration as in the configuration of the present embodiment, it is possible to eliminate, from the connection surface 12A or the connection surface 21A, an area which is necessary for bonding or welding the connecting member to the connection surface 12A or the connection surface 21A, and the connection surface 12A and the connection surface 21A can be narrowed. Further, by virtue of this feature, it becomes possible to reduce the size of the optical unit 1, in particular. Note that the connection surface to which the connecting member is connected (i.e., the connection surface 12A and the connection surface 21A) may be made of metal or resin, for example, and the materials thereof are not particularly limited.

Further, in the optical unit 1 of the present embodiment, in both of the fixed body 10 and the fixed-body-side leg portion 30A as a pair and the movable body 20 and the movable-body-side leg portion 30B as a pair, the corresponding members of the pair are directly connected to each other without any other member interposed therebetween. By employing such a configuration, it is possible to reduce the size of both the connection portion between the fixed body 10 and the gimbal mechanism 30 and the connection portion between the movable body 20 and the gimbal mechanism 30. Thus, it becomes possible to reduce the size of the optical unit 1, in particular.

However, at least an embodiment of the present invention is not limited to such a configuration. In other words, it suffices that in only one of the fixed body 10 and the fixed-body-side leg portion 30A as a pair and the movable body 20 and the movable-body-side leg portion 30B as a pair, the corresponding members of the pair are directly connected to each other without any other member interposed therebetween. Further, in a case where there are a plurality of connection portions between the fixed body 10 and the gimbal mechanism 30 and between the movable body 20 and the gimbal mechanism 30, it suffices that in at least one of those connection portions, the fixed body 10 and the fixed-body-side leg portion 30A, and the movable body 20 and the movable-body-side leg portion 30B are directly connected to each other without any other member interposed therebetween.

In addition, as illustrated in FIG. 7 and the like, in the optical unit 1 of the present embodiment, the movable body 20 and the movable-body-side leg portion 30B are connected to each other by means of the convex portion 31 and the concave portion 81 engaged with the convex portion 31. Similarly, in the optical unit 1 of the present embodiment, the fixed body 10 and the fixed-body-side leg portion 30A are also connected to each other by means of the convex portion 31 and the concave portion 81 engaged with the convex portion 31. As described above, preferably, the optical unit 1 should be configured such that in at least one of the fixed body 10 and the fixed-body-side leg portion 30A as a pair and the movable body 20 and the movable-body-side leg portion 30B as a pair, the corresponding members of the pair are connected to each other by means of the convex portion 31 and the concave portion 81 engaged with the convex portion 31.

The reason for employing such a configuration is that it becomes possible to easily structure the convex portion 31 and the concave portion 81, and also, the fixed body 10, the movable body 20, and the gimbal mechanism 30 are allowed to be easily slidable at the convex portion 31 and the concave portion 81, whereby the movable body 20 can be easily rotated relative to the fixed body 10. However, the configuration is not limited to the above-described configuration. For example, a columnar projection portion may be provided instead of the convex portion 31, and a circular hole into which the projection portion is inserted may be adopted instead of the concave portion 81.

In addition, in the optical unit 1 of the present embodiment, the convex portion 31 is configured by deforming a part of the fixed-body-side leg portion 30A and the movable-body-side leg portion 30B, which are both flat and plate-like. Consequently, it is possible to reduce the number of components of the connection portion of the fixed body 10 and the movable body 20 to the gimbal mechanism 30 which results from the configuring of the convex portion 31.

However, the configuration is not limited to the above-described configuration. For example, such a configuration in which a ball-like member or the like is welded or bonded to the flat and plate-like fixed-body-side leg portion 30A and movable-body-side leg portion 30B may be employed. By employing the configuration in which the ball-like member or the like is welded or bonded to the fixed-body-side leg portion 30A and the movable-body-side leg portion 30B, it is possible to easily increase the amount of protrusion toward the concave portion 81. In addition, since the convex portion 31 can be configured to be stiff, the pressure G to be applied can be increased, and a support force exhibited in supporting the fixed body 10 and the movable body 20 by the gimbal mechanism 30 can be made stronger.

Further, in the optical unit 1 of the present embodiment, the convex portion 31 is provided on the fixed-body-side leg portion 30A and the concave portion 81 is provided on the fixed body 10, and moreover, the convex portion 31 is provided on the movable-body-side leg portion 30B and the concave portion 81 is provided on the movable body 20. As described above, preferably, at least one of a condition that the convex portion 31 is provided on the fixed-body-side leg portion 30A and the concave portion 81 is provided on the fixed body 10 and a condition that the convex portion 31 is provided on the movable-body-side leg portion 30B and the concave portion 81 is provided on the movable body 20 should be satisfied. The reason for employing such a configuration is that it becomes possible to easily form the connection portion of the fixed body 10 and the movable body 20 to the gimbal mechanism 30.

However, the configuration is not limited to the above-described configuration. Alternatively, a configuration in which a concave portion is provided on the fixed-body-side leg portion 30A and a convex portion is provided on the fixed body 10 may be employed, or a configuration in which a concave portion is provided on the movable-body-side leg portion 30B and a convex portion is provided on the movable body 20 may be employed. By employing such a configuration, in connecting the fixed body 10 and the movable body 20 to the gimbal mechanism 30, the connection is facilitated.

Specifically, when the fixed body 10 and the gimbal mechanism 30 are connected to each other, the gimbal mechanism 30 is moved relative to the fixed body 10 in the −Z direction to establish the connection. In doing so, the gimbal mechanism 30 is moved in a state in which the convex portion 31 of the fixed-body-side leg portion 30A and a projection portion 32, which will be described later, abut against the connection surface 12A. By employing the configuration in which the concave portion is provided on the fixed-body-side leg portion 30A and the convex portion is provided on the fixed body 10, it is possible to reduce the movement distance in the abutted state and a pressure caused by the movement.

Similarly, when the movable body 20 and the gimbal mechanism 30 are connected to each other, the gimbal mechanism 30 is moved relative to the movable body 20 in the −Z direction to establish the connection. In doing so, the gimbal mechanism 30 is moved in a state in which the convex portion 31 of the movable-body-side leg portion 30B and the projection portion 32 to be described later abut against the connection surface 21A. By employing the configuration in which the concave portion is provided on the movable-body-side leg portion 30B and the convex portion is provided on the movable body 20, it is possible to reduce the movement distance in the abutted state and a pressure caused by the movement.

In addition, as illustrated in FIGS. 3 to 6, in the optical unit 1 of the present embodiment, the projection portion 32, which protrudes toward the inner side, is provided on each of the fixed-body-side leg portion 30A and the movable-body-side leg portion 30B, and a hole part 82 into which the projection portion 32 is fitted is provided in each of the connection surface 12A of the fixed body 10 and the connection surface 21A of the movable body 20. As described above, in at least one of the fixed body 10 and the fixed-body-side leg portion 30A as a pair and the movable body 20 and the movable-body-side leg portion 30B as a pair, the corresponding members of the pair should preferably be connected to each other by means of the projection portion 32 and the hole part 82 into which the projection portion 32 is fitted, in addition to the convex portion 31 and the concave portion 81. This is because as the connection is established by the projection portion 32 and the hole part 82, in addition to the convex portion 31 and the concave portion 81, the gimbal mechanism 30 can be prevented from being detached from the fixed body 10 and the movable body 20.

Furthermore, as illustrated in FIGS. 5, 6, 8, and the like, around the convex portion 31 and the concave portion 81, the optical unit 1 of the present embodiment includes a projection portion 32A, a projection portion 32B, and a projection portion 32C as the projection portion 32, and also includes a hole part 82A, a hole part 82B, and a hole part 82C as the hole part 82. As described above, preferably, the projection portion 32 and the hole part 82 should be provided at a plurality of places around the convex portion 31 and the concave portion 81. The reason for employing such a configuration is that it becomes possible to suitably prevent the gimbal mechanism 30 from being detached from the fixed body 10 and the movable body 20.

Finally, at least an embodiment of the present invention will be comprehensively described below.

(1)

An optical unit comprising: a fixed body; a movable body provided with a lens unit; and a gimbal mechanism which supports the movable body such that the movable body is rotatable relative to the fixed body about a direction intersecting an optical axis direction as an axis of rotation, wherein: the gimbal mechanism includes a fixed-body-side leg portion connected to the fixed body, and a movable-body-side leg portion connected to the movable body; and in at least one of the fixed body and the fixed-body-side leg portion as a pair and the movable body and the movable-body-side leg portion as a pair, corresponding members of the pair are directly connected to each other without any other member interposed therebetween.

(2)

The optical unit according to (1) above, wherein in both of the fixed body and the fixed-body-side leg portion as a pair and the movable body and the movable-body-side leg portion as a pair, the corresponding members of the pair are directly connected to each other without any other member interposed therebetween.

(3)

The optical unit according to (1) or (2) above, wherein in at least one of the fixed body and the fixed-body-side leg portion as a pair and the movable body and the movable-body-side leg portion as a pair, the corresponding members of the pair are connected to each other by means of a convex portion and a concave portion engaged with the convex portion.

(4)

The optical unit according to (3) above, wherein the optical unit satisfies at least one of a condition that the convex portion is provided on the fixed-body-side leg portion and the concave portion is provided on the fixed body and a condition that the convex portion is provided on the movable-body-side leg portion and the concave portion is provided on the movable body.

(5)

The optical unit according to (3) or (4) above, wherein in at least one of the fixed body and the fixed-body-side leg portion as a pair and the movable body and the movable-body-side leg portion as a pair, the corresponding members of the pair are connected to each other by means of a projection portion and a hole part into which the projection portion is fitted, in addition to the convex portion and the concave portion.

(6)

The optical unit according to (5) above, wherein the projection portion and the hole part are provided at a plurality of places around the convex portion and the concave portion.

What is claimed is:

1. An optical unit comprising:
a fixed body;
a movable body provided with a lens unit; and
a gimbal mechanism which supports the movable body such that the movable body is rotatable relative to the fixed body about a direction intersecting an optical axis direction as an axis of rotation, wherein:
the gimbal mechanism comprises a fixed-body-side leg portion connected to the fixed body, and a movable-body-side leg portion connected to the movable body; and
in at least one of the fixed body and the fixed-body-side leg portion as a pair and the movable body and the movable-body-side leg portion as a pair, corresponding members of the pair are directly connected to each other without any other member interposed therebetween.

2. The optical unit according to claim 1, wherein
in both of the fixed body and the fixed-body-side leg portion as a pair and the movable body and the movable-body-side leg portion as a pair, the corresponding members of the pair are directly connected to each other without any other member interposed therebetween.

3. The optical unit according to claim 1, wherein
in at least one of the fixed body and the fixed-body-side leg portion as a pair and the movable body and the movable-body-side leg portion as a pair, the corresponding members of the pair are connected to each other by means of a convex portion and a concave portion engaged with the convex portion.

4. The optical unit according to claim 3, wherein
the optical unit satisfies at least one of a condition that the convex portion is provided on the fixed-body-side leg portion and the concave portion is provided on the fixed body and a condition that the convex portion is provided on the movable-body-side leg portion and the concave portion is provided on the movable body.

5. The optical unit according to claim 3, wherein
in at least one of the fixed body and the fixed-body-side leg portion as a pair and the movable body and the movable-body-side leg portion as a pair, the corresponding members of the pair are connected to each other by means of a projection portion and a hole part into which the projection portion is fitted, in addition to the convex portion and the concave portion.

6. The optical unit according to claim 5, wherein
the projection portion and the hole part are provided at a plurality of places around the convex portion and the concave portion.

7. The optical unit according to claim 2, wherein
in at least one of the fixed body and the fixed-body-side leg portion as a pair and the movable body and the movable-body-side leg portion as a pair, the corresponding members of the pair are connected to each other by means of a convex portion and a concave portion engaged with the convex portion.

8. The optical unit according to claim 7, wherein
the optical unit satisfies at least one of a condition that the convex portion is provided on the fixed-body-side leg portion and the concave portion is provided on the fixed body and a condition that the convex portion is provided on the movable-body-side leg portion and the concave portion is provided on the movable body.

9. The optical unit according to claim 7, wherein
in at least one of the fixed body and the fixed-body-side leg portion as a pair and the movable body and the movable-body-side leg portion as a pair, the corresponding members of the pair are connected to each other by means of a projection portion and a hole part into which the projection portion is fitted, in addition to the convex portion and the concave portion.

10. The optical unit according to claim 9, wherein
the projection portion and the hole part are provided at a plurality of places around the convex portion and the concave portion.
